(19) United States
(12) Patent Application Publication
(10) Pub. No.: US 2014/0172559 A1
(43) Pub. Date: Jun. 19, 2014

(54) SYSTEM AND METHODS FOR PROVIDING LOCATION-BASED GOAL BALANCE INFORMATION

(71) Applicant: BANK OF AMERICA CORPORATION, Charlotte, NC (US)

(72) Inventors: Matthew A. Calman, Charlotte, NC (US); Carrie Anne Hanson, Charlotte, NC (US); David M. Grigg, Rock Hill, SC (US); Susan Smith Thomas, Gastonia, NC (US); Peter John Bertanzetti, Charlotte, NC (US); Elizabeth S. Votaw, Potomac, MD (US)

(73) Assignee: BANK OF AMERICA CORPORATION, Charlotte, NC (US)

(21) Appl. No.: 13/713,585

(22) Filed: Dec. 13, 2012

(51) Int. Cl. G06Q 40/00

(52) U.S. Cl. CPC G06Q 40/00
USPC 705/14.53; 705/26.9; 705/38

(57) ABSTRACT

Systems, methods, and computer program products are provided for providing a notification to a consumer based on the location of the consumer. The system includes a computer apparatus including a processor and a memory; and a software module stored in the memory. The software module includes executable instructions that cause the processor to receive a goal corresponding to a specific product a consumer desires to purchase; determine a location associated with a mobile device of the consumer; identify a merchant that is located at or near the location associated with the mobile device of the consumer; determine whether the merchant offers for sale the specific product associated with the goal; provide a notification to the mobile device associated with the consumer based at least in part on determining that the merchant offers for sale the product, the notification comprising information related to the user's progress towards the goal.

### BACKGROUND

Consumers often have goals for saving money for prospective purchases. In many instances, the consumers have to save money for being able to make the goal purchase but frequently, while on the go, do not have an efficient and reliable means for determining what all of their goals are and whether they have saved up enough money to make the goal purchase. As such, there is a need to provide consumers with a reliable and efficient means for managing their goals on the go.

### BRIEF SUMMARY

The following presents a simplified summary of one or more embodiments of the invention in order to provide a basic understanding of such embodiments. This summary is not an extensive overview of all contemplated embodiments and is not intended to identify key or critical elements of all embodiments or delineate the scope of any or all embodiments. Its sole purpose is to present some concepts of one or more embodiments in a simplified form as a prelude to the more detailed description that is presented later.

Embodiments of the present invention provide a system for providing information related to a goal of a user based on location. The system includes: a mobile computing device including a processor and a memory; and a software module stored in the memory, comprising executable instructions that when executed by the processor causes the processor to: receive a goal from a consumer, wherein the goal corresponds to a specific product the consumer desires to purchase and a money or credit amount the consumer desires to save for purchasing the specific product in the future; determine a location associated with a mobile device of the consumer; identify a merchant that is located at or near the location associated with the mobile device of the consumer; determine whether the merchant offers for sale the specific product associated with the goal.

In some embodiments, the system is further configured to determine whether the money or credit amount associated with the goal is met; and provide a notification to the mobile device associated with the consumer based at least in part on determining that the merchant offers for sale the product, the notification comprising information related to the progress of the user towards the goal.

In some embodiments, the system is further configured to determine whether the money or credit amount associated with the goal is met; determine, when the money or credit amount associated with the goal is not met, a difference between a real-time or substantially real-time price of the specific product and a current amount of the money or credit amount the consumer has available for purchasing the specific product; and provide a recommendation to the consumer for a payment option for paying for the determined difference, wherein the recommendation comprises one of at least a recommendation to pay for the determined difference using an existing or by opening a new credit line, by transferring funds from a financial account, or by using an payment installment plan.

In some embodiments, the system is further configured to receive sales or promotions information associated with the specific product, wherein the sales or promotions relate to at least one of financing opportunities, coupons, rebates, or discounts available to the user for reducing the overall price of the specific product; and provide a recommendation to the consumer for a sale or promotion based at least in party on an analysis of the received sales or promotions and determining that at least one of the sales or promotions together with a current balance of the money or credit amount is sufficient for purchasing the specific product by the consumer.

In some embodiments, the system is further configured to send a notification to the identified merchant. In some embodiments, the notification comprises information indicating that the consumer is at or near the identified merchant and further indicating that the consumer has a goal corresponding to a specific product that the identified merchant has for sale; and allow the identified merchant to send, in real-time or substantially real-time, an offer to the mobile device associated with the consumer and while the consumer is at or near the identified merchant.

In some embodiments of the computer-implemented method, wherein the information related to the progress of the user towards the goal includes at least a balance of a financial account having the money or credit amount the user has accumulated for purchasing the specific product, the goal amount, and a current price of the specific product.

In some embodiments, the system is further configured to receive a plurality of goals from the consumer, wherein each of the plurality of goals correspond to a specific product the consumer desires to purchase and a money or credit amount the consumer desires to save for purchasing the specific product in the future; identify a plurality of merchants that are located at or near the location associated with the mobile device of the consumer; and present, via the mobile device of the consumer, a two or more notifications based at least in part on determining that at least one of the plurality of merchants offers two or more specific products associated with the plurality of goals of the consumer.

In one aspect of the invention, a computer-implemented method is provided for providing information related to a goal of a user based on location. The computer-implemented method includes using a computer processor to execute computer program code instructions stored in one or more non-transitory computer-readable mediums, wherein said computer program code instructions are structured to cause said computer processor to: receive a goal from a consumer, wherein the goal corresponds to a specific product the consumer desires to purchase and a money or credit amount the consumer desires to save for purchasing the specific product in the future; determine a location associated with a mobile device of the consumer; identify a merchant that is located at or near the location associated with the mobile device of the consumer; determine whether the merchant offers for sale the specific product associated with the goal; and provide a notification to the mobile device associated with the consumer based at least in part on determining that the merchant offers for sale the product, the notification comprising information related to the progress of the user towards the goal.

In some embodiments, the computer-implemented method is further configured to determine whether the money or credit amount associated with the goal is met; and provide a notification to the mobile device associated with the consumer based at least in part on determining that the merchant offers for sale the product, the notification comprising information related to the progress of the user towards the goal

In some embodiments, the computer-implemented method is further configured to determine whether the money or credit amount associated with the goal is met; determine, when the money or credit amount associated with the goal is not met, a difference between a real-time or substantially real-time price of the specific product and a current amount of the money or credit amount the consumer has available for purchasing the specific product; and provide a recommendation to the consumer for a payment option for paying for the determined difference, wherein the recommendation comprises one of at least a recommendation to pay for the determined difference using an existing or by opening a new credit line, by transferring funds from a financial account, or by using an payment installment plan.

In some embodiments, the computer-implemented method is further configured to receive sales or promotions information associated with the specific product, wherein the sales or promotions relate to at least one of financing opportunities, coupons, rebates, or discounts available to the user for reducing the overall price of the specific product; and provide a recommendation to the consumer for a sale or promotion based at least in party on an analysis of the received sales or promotions and determining that at least one of the sales or promotions together with a current balance of the money or credit amount is sufficient for purchasing the specific product by the consumer.

In some embodiments, the computer-implemented method is further configured to send a notification to the identified merchant, the notification comprising information indicating that the consumer is at or near the identified merchant and further indicating that the consumer has a goal corresponding to a specific product that the identified merchant has for sale; and allow the identified merchant to send, in real-time or substantially real-time, an offer to the mobile device associated with the consumer and while the consumer is at or near the identified merchant.

In some embodiments of the computer-implemented method, wherein the information related to the progress of the user towards the goal includes at least a balance of a financial account having the money or credit amount the user has accumulated for purchasing the specific product, the goal amount, and a current price of the specific product.

In some embodiments, the computer-implemented method is further configured to receive a plurality of goals from the consumer, wherein each of the plurality of goals correspond to a specific product the consumer desires to purchase and a money or credit amount the consumer desires to save for purchasing the specific product in the future; identify a plurality of merchants that are located at or near the location associated with the mobile device of the consumer; and present, via the mobile device of the consumer, a two or more notifications based at least in part on determining that at least one of the plurality of merchants offers two or more specific products associated with the plurality of goals of the consumer.

In another aspect, a computer program product for providing information related to a goal of a user is provided.

In some embodiments, the computer program product is further configured to determine whether the money or credit amount associated with the goal is met; and provide a notification to the mobile device associated with the consumer based at least in part on determining that the merchant offers for sale the product, the notification comprising information related to the progress of the user towards the goal

In some embodiments, the computer program product is further configured to determine whether the money or credit amount associated with the goal is met; determine, when the money or credit amount associated with the goal is not met, a difference between a real-time or substantially real-time price of the specific product and a current amount of the money or credit amount the consumer has available for purchasing the specific product; and provide a recommendation to the consumer for a payment option for paying for the determined difference, wherein the recommendation comprises one of at least a recommendation to pay for the determined difference using an existing or by opening a new credit line, by transferring funds from a financial account, or by using an payment installment plan.

In some embodiments, the computer program product is further configured to receive sales or promotions information associated with the specific product, wherein the sales or promotions relate to at least one of financing opportunities, coupons, rebates, or discounts available to the user for reducing the overall price of the specific product; and provide a recommendation to the consumer for a sale or promotion based at least in party on an analysis of the received sales or promotions and determining that at least one of the sales or promotions together with a current balance of the money or credit amount is sufficient for purchasing the specific product by the consumer.

In some embodiments, the computer program product is further configured to send a notification to the identified merchant, the notification comprising information indicating that the consumer is at or near the identified merchant and further indicating that the consumer has a goal corresponding to a specific product that the identified merchant has for sale; and allow the identified merchant to send, in real-time or substantially real-time, an offer to the mobile device associated with the consumer and while the consumer is at or near the identified merchant.

In some embodiments of the computer program product, wherein the information related to the progress of the user towards the goal includes at least a balance of a financial account having the money or credit amount the user has accumulated for purchasing the specific product, the goal amount, and a current price of the specific product.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram illustrating a location-based balance information push system and environment in accordance with an embodiment of the invention;

FIG. 2 provides a block diagram illustrating the consumer mobile device of FIG. 1 in more detail in accordance with an embodiment of the invention;

FIG. 3 provides a block diagram illustrating the financial management system of FIG. 1 in more detail in accordance with an embodiment of the invention;

FIG. 4 provides a block diagram illustrating the merchant system of FIG. 1 in more detail in accordance with an embodiment of the invention;

FIG. 5 provides a block diagram illustrating the location-based balance communication system of FIG. 1 in more detail in accordance with an embodiment of the invention;

FIG. 6 provides a flow chart illustrating a location-based balance information process in accordance with an embodiment of the invention;

FIG. 7 provides a flow chart illustrating a modified location-based balance information process in accordance with an embodiment of the invention.

### DETAILED DESCRIPTION OF EMBODIMENTS OF THE INVENTION

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. Additionally, while embodiments are disclosed as “comprising” elements, it should be understood that the embodiments may also “consist of” elements or “consist essentially of” elements.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. As used herein, the term “user” includes a customer of a financial institution, a financial account holder, an agent of an account holder, a user associated with a payment device, a merchant, an employee of a merchant, a business or non-profit entity, and the like. The term “merchant” may mean a brick and mortar merchant, an internet retailer a service provider, a mobile merchant, or the like, and thus a point of sale for a transaction may instead by a time of sale for the transaction.

Some embodiments of the invention are directed to a location-based balance information push solution or system that provides relevant information regarding product or service purchase goals to a user on the go based on the determining location of the user. The system, such as by a user's mobile device, detects a user's current location, and based on the user's current location together with the user's purchase goals information and financial account savings information, provides information or advice regarding the savings balances for at least one of the user's purchase goals. For example, in some embodiments, the system determines that the user is at a retail store location that provides at least one product that the user has set a goal for purchasing. In such an example, the system analyzes the amounts saved toward purchasing the goal product and provides a notification to the user that includes information relating to the user's progress towards saving for the goal.

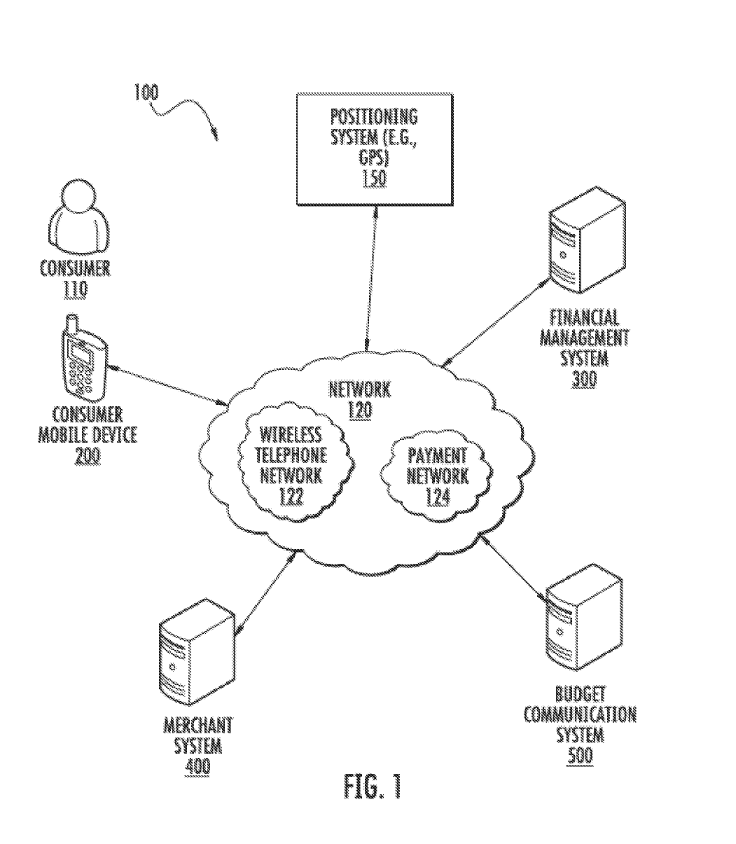

Referring now to the figures, FIG. 1 provides a block diagram illustrating a mobile commerce system and environment 100 in accordance with an embodiment of the invention. As illustrated, the system 100 generally includes a consumer 110, a network 120, a positioning system 150, a consumer mobile device 200, a financial management system 300, a merchant system 400, and a balance communication system 500. The consumer 110 may be any individual or entity with the potential to purchase products from a merchant. As used herein, the term “products” refers to goods, services, and/or the like. As used herein, the term “merchant” refers to any entity involved in advertising, promoting, offering, creating, manufacturing, selling, or otherwise providing one or more products to one or more consumers. For example, the merchant may be a manufacturer, retailer, wholesaler, advertiser, marketer, distributor, and/or the like.

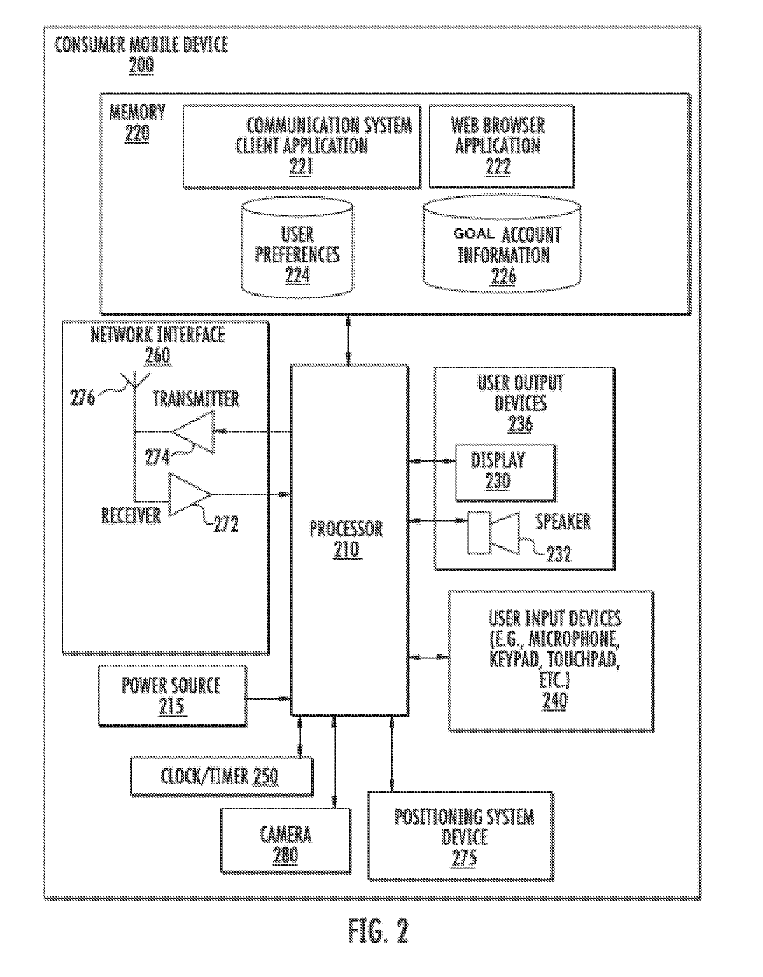

The consumer 110 has a mobile device 200, such as a mobile phone, personal digital assistant (PDA), personal navigation device, personal web-surfing device, or other personal/mobile computing device. Embodiments of the consumer mobile device 200 are described in greater detail in FIG. 2 and the accompanying description.

The network 120 may be any of one or more devices or connections communicably coupling two or more devices. For example, the network 120 may include a global area network, such as the Internet, a wide area network, a local area network, a wireless network, a wire-line network, one or more modems, one or more servers, one or more relay devices, one or more direct electrical connections, one or more satellites, and/or the like, or a combination thereof. As illustrated, in some embodiments, the network 120 includes a wireless telephone network 122, such as a cellular network or other mobile telephone/data network known in the art. As also illustrated, in some embodiments, the network 120 includes a payment network 124 for processing electronic or other payments and transferring money between banks and other entities. For example, the payment network 124 may include the networks of one or more banks or other well-known payment network and/or the like.

According to various embodiments, the positioning system 150 may be the well-known Global Positioning System (GPS) or other systems for identifying precise geographical locations of individuals or devices or positions of individuals or devices relative to known objects or locations. For example, some embodiments of the invention include a positioning system that can identify the current latitude and longitude, and in some cases altitude, of the consumer's mobile device 200 using a sensor/transceiver in the consumer's mobile device 200 in conjunction with a satellite system and/or the wireless telephone network 122. In other embodiments, more local sensors/transceivers interact with sensors/transceivers of the consumer's mobile device 200 to determine if the consumer 110 is within a certain distance from a merchant and/or moving toward or away from the merchant. For example, in one embodiment of the invention, a merchant has sensors at its entrances that can communicate with consumer mobile devices 200 that have near field communication (NFC) capabilities and, thereby, determine when the consumer 110 possessing the consumer mobile device 200 enters or leaves the merchant's facility.

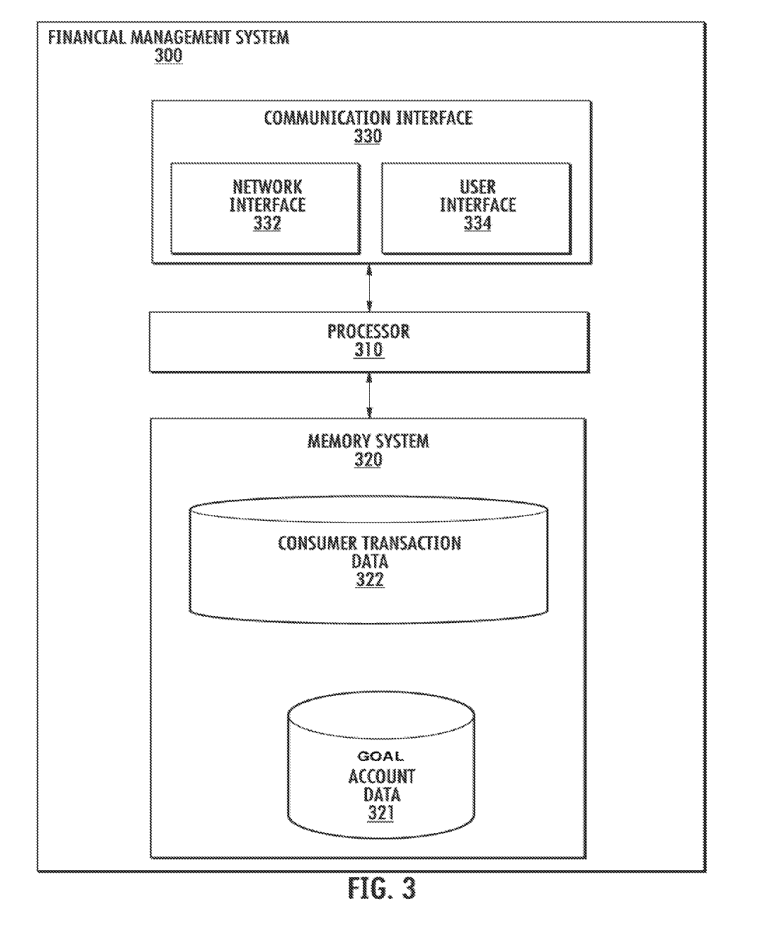

The financial management system 300 stores financial information for the consumer 110 and/or the merchant, including goal information for one or more goal accounts set up by the consumer 110. Each of the goal accounts correspond with various specific consumer products or services (e.g., television, sofa, or the like) specified by the consumer. According to various embodiments, the goal information for each goal account includes, for example, a goal account name, a goal account product or service (e.g., television, sofa, or the like), a goal amount of money or credit to be accumulated or saved over a period of time by the consumer for purchasing the goal account product or service, a balance amount indicating a current amount of money or credit accumulated by the consumer in the goal account, and credit and/or withdrawal rules associated therewith, and the like. Embodiments of the financial management system 300 and goal information are described in greater detail in FIG. 3 and the accompanying description.

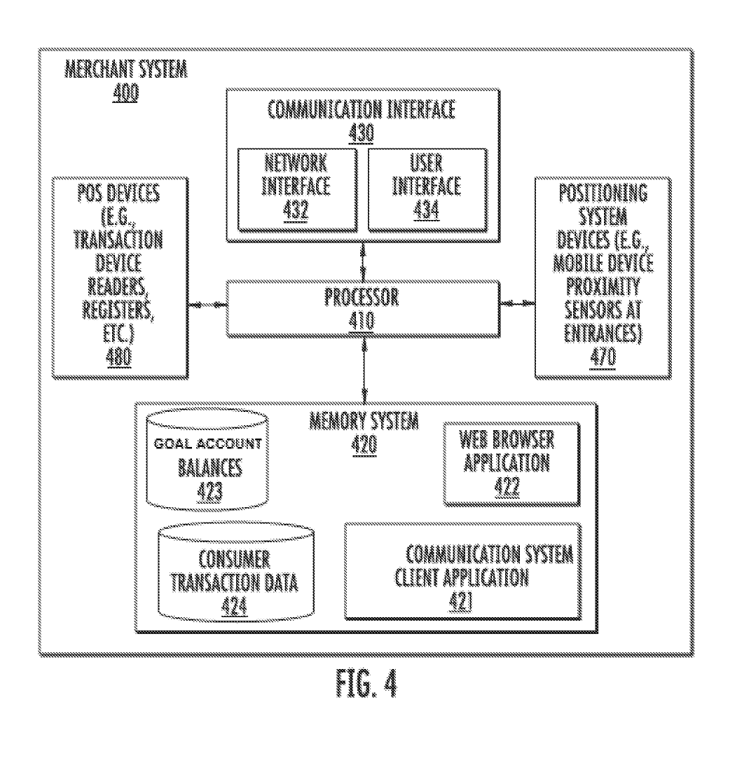

According to various embodiments, the merchant system 400 processes transactions between the consumer 110 and the merchant and allows the merchant to interact with the goal communication system 500. The merchant system 400 also stores balance information (e.g., amount of money or credit accumulated in the goal accounts) for products or service that the consumer desires to purchase at the merchant's location(s). Embodiments of the merchant system 400 are described in greater detail in FIG. 4 and the accompanying description.

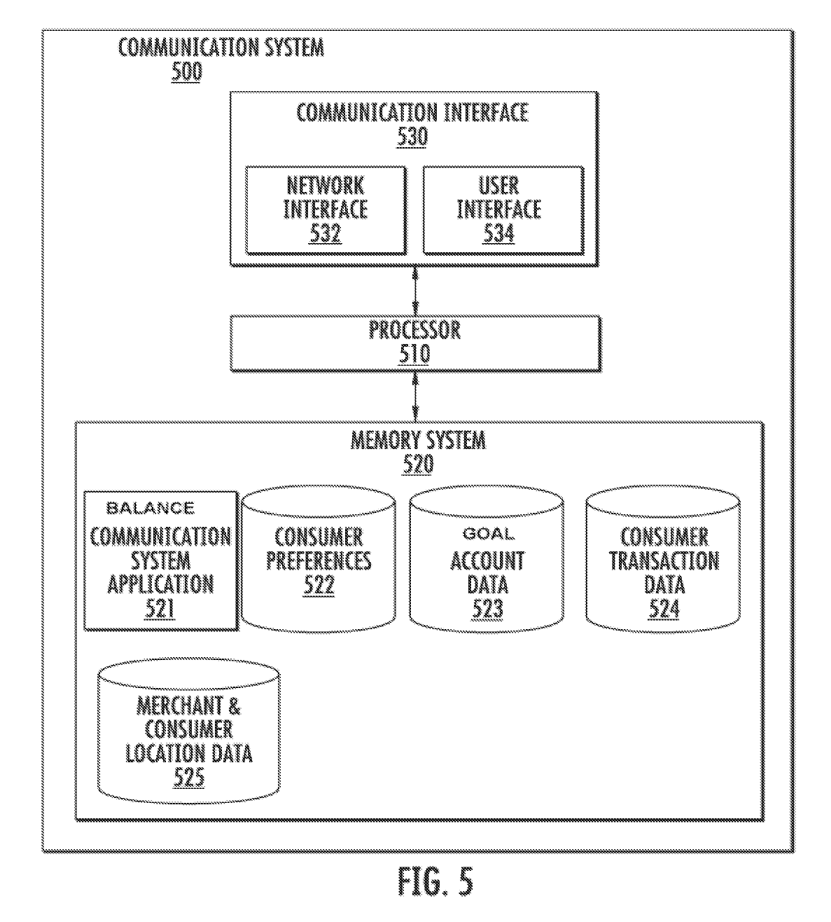

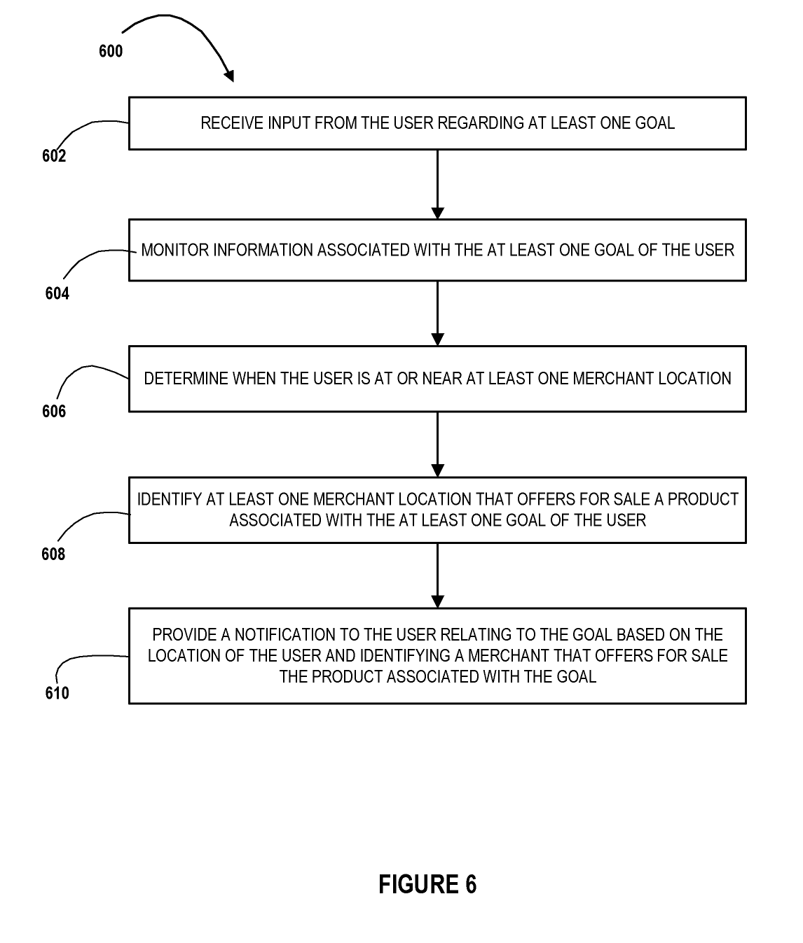

According to various embodiments, the balance communication system 500 provides relevant goal account information, merchant deals or offers, and/or merchant locations that offer products or services associated with the goals of the consumer to the mobile device 200 when the consumer 110 is near or entering the merchant's facility. Embodiments of the various processes, features, and functions managed by the balance communication system 500 are described below in FIGS. 6 through 8 and the accompanying descriptions. Embodiments of the balance communication system 500 are also described in greater detail in FIG. 5 and the accompanying description.

For example, as described in greater detail below, in one embodiment of the system 100, a consumer's location relative to one or more merchants is tracked using the positioning system 150 and the consumer's mobile device 200. The balance communication system 500 receives the position of the consumer's mobile device from the positioning system 150, identifies the type(s) of merchant(s) located near the consumer's mobile device 200, retrieves goal information related to each goal account set up by the consumer, and communicates the retrieved goal information to the consumer's mobile device 200 for display thereon. In addition, according to one embodiment, the balance communication system 500 and/or the financial management system 300 determines trends in the consumer's shopping behavior based on information stored by the financial management system 300, and these trends are used to determine which of two or more merchants the consumer is more likely to be visiting at a particular time of the day, when, for example, there are two or more merchants located near the consumer's mobile device 200.

FIG. 2 provides a block diagram illustrating the consumer mobile device 200 of FIG. 1 in more detail in accordance with an embodiment of the invention. In one embodiment of the invention, the mobile device 200 is a mobile telephone. However, it should be understood that a mobile telephone is merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, mobile televisions, gaming devices, laptop computers, cameras, video recorders, audio/video player, radio, GPS devices, or any combination of the aforementioned.

The mobile device 200 generally includes a processor 210 communicably coupled to such devices as a memory 220, user output devices 236, user input devices 240, a network interface 260, a power source 215, a clock or other timer 250, a camera 280, and a positioning system device 275. The processor 210, and other processors described herein, generally include circuitry for implementing communication and/or logic functions of the mobile device 200. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like.

The processor 210 is configured to use the network interface 260 to communicate with one or more other devices on the network 120. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 122. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 200 may also be configured to operate in accordance with non-cellular communication mechanisms, such as via a wireless local area network (WLAN) or other communication/data networks.

The network interface 260 may also include a payment network interface 270. The payment network interface 270 may include software, such as encryption software, and hardware, such as a modem, for communicating information to and/or from one or more devices on the payment network 124. For example, the mobile device 200 may be configured so that it can be used as a credit or debit card by, for example, wirelessly communicating account numbers or other authentication information to a POS terminal of the payment network 124 and/or merchant system 400.

As described above, the mobile device 200 has a user interface that is, like other user interfaces described herein, made up of user output devices 236 and/or user input devices 240. The user output devices 236 include a display 330 (e.g., a liquid crystal display or the like) and a speaker 232 or other audio device, which are operatively coupled to the processor 210. The user input devices 240, which allow the mobile device 200 to receive data from a user such as the consumer 110, may include any of a number of devices allowing the mobile device 200 to receive data from the user, such as a keypad, keyboard, touch-screen, touchpad, microphone, mouse, joystick, other pointer device, button, soft key, and/or other input device(s). The user interface may also include a camera 280, such as a digital camera.

The mobile device 200 also includes a positioning system device 275 that is configured to be used by the positioning system 150 to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a merchant or other location to determine that the consumer mobile device 200 is located proximate these known devices.

The mobile device 200 further includes a power source 215, such as a battery, for powering various circuits and other devices that are used to operate the mobile device 200. Embodiments of the mobile device 200 may also include a clock or other timer 500 configured to determine and, in some cases, communicate actual or relative time to the processor 210 or one or more other devices.

The mobile device 200 also includes a memory 220 operatively coupled to the processor 210. As used herein, memory includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which comprise computer-executable instructions/code executed by the processor 210 to implement the functions of the mobile device 200 described herein. For example, the memory 220 may include such applications as a conventional web browser application 222 and/or a balance communication system client application 221. These applications also typically provide a graphical user interface (GUI) on the display 330 that allows the consumer 110 to communicate with the consumer mobile device 200, the balance communication system 500, and/or other devices. In one embodiment of the invention, when the consumer 110 decides to enroll in the balance communication program, the consumer 110 downloads the balance communication system client application 221 from the balance communication system 500. In other embodiments of the invention, the consumer 110 interacts with the balance communication system 500 via the web browser application 220 in addition to, or instead of, the balance communication system client application 221.

The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user preferences information 224 or goal information 226 related to one or more goal accounts.

The user preferences information 224 may include, for example, information used by the goal communication system 500 to determine the identity of the user, what type of goal information, purchasing trend(s), or goal account information the user wants to see, when the user would like to receive each type of information, how the user would like to receive each type information, when the user would like for the user's location to be available to the goal communication system 500, and/or the like. The user preference information 224 may be requested, for example, by the goal communication system client application 221 via the user output devices 236, and may be entered by the consumer 110 via the user input devices 240 and then stored by the processor 210 in the memory 220 and, in some cases, communicated to the goal communication system 500 via the network interface 260. In some embodiments, the user preferences include a digital certificate or other file used by the goal communication system 500 to identify and/or authenticate the consumer 110 associated with the mobile device 200 in a secure and/or encrypted way. Some examples of user preferences 224 are described in greater detail below with reference to the flow charts.

FIG. 3 provides a block diagram illustrating the financial management system 300 of FIG. 1 in more detail in accordance with an embodiment of the invention. The financial management system 300 generally includes a processor 310 communicably coupled to a communication interface 330 and a memory system 320. Like the processor 210 described with respect to FIG. 2, the processor 310 comprises the circuitry and logic to perform the various functions of the financial management system 300 described herein. The communication interface 330 includes a network interface 332 and a user interface 334, which may be similar to those described above with respect to FIG. 2. In one embodiment, the financial management system 300 is a computer system of a bank or other financial institution configured to process financial transactions (e.g., credit or debit card transactions and/or the like) for consumers and/or merchants having accounts with the bank or other financial institution.

According to various embodiments, the memory system 320 stores goal account data 321 related to one or more goal accounts set up by the consumer 110 and consumer transaction data 322 related to one or more financial transactions made by the consumer 110 through the financial institution. The goal account data 321 includes a goal account name, a goal account product or service, an amount of money or credit to be accumulated for purchasing the goal account product or service, notification rules associated with each goal account, according to various embodiments. In addition, in certain embodiments, the financial management system 300 provides systems and/or processes for assisting the consumer 110 with creating one or more goal accounts, such as the systems and processes described in U.S. application Ser. No. 12/821,631, entitled “Active Goal Control” and filed Jun. 23, 2010, which is herein incorporated by reference in its entirety.

Furthermore, financial institutions have access to large amounts of consumer data because they maintain or administer their customers' various financial accounts (e.g., credit card accounts, checking accounts, savings accounts, etc.) and because they have data related to their customers' purchases. Financial institutions track and store data related to the goods or services (e.g., “products”) that customers purchase, when their customers make their purchases, where the customers make their purchases, how much the customers spend, and/or the like, both for online and offline purchases. In addition, financial institutions have direct ties with many different merchants that use the financial institutions for their own financial needs. Accordingly, financial institutions are in a unique position to track consumer transaction data for purchases made by the consumer. In various embodiments, the consumer transaction data 322 includes information about one or more consumer transactions, such as transaction amount, date/time, location, merchant, products, transaction type, payment method, and/or the like. In addition, according to some embodiments, the financial system 300 may also track spending trends of the consumer 110 at one or more merchants over a particular time period (e.g., a week, month, quarter, year, etc.).

FIG. 4 provides a block diagram illustrating the merchant system 400 of FIG. 1 in more detail in accordance with an embodiment of the invention. The merchant system 400 generally includes a processor 410 communicably coupled to a communication interface 430 and a memory system 420. Like the processor 210 described with respect to FIG. 2, the processor 410 comprises the circuitry and logic to perform the various functions of the merchant system 400 described herein. The communication interface 430 includes a network interface 432 and a user interface 434, which may be similar to those described above with respect to FIG. 2.

The memory system 420 may include a web browser application 422 and/or a goal communication system client application 421 which comprise computer-executable instructions/code executed by the processor 410 to implement at least some of the functions of the merchant system 400 described herein. These applications also typically provide a graphical user interface (GUI) on the user interface 434 that allows a merchant representative to communicate with the goal communication system 500 and/or other devices. In one embodiment of the invention, a merchant representative downloads the goal communication system client application 421 from the goal communication system 500. In other embodiments of the invention, the merchant interacts with the goal communication system 500 by using the web browser application 220 to access and log into a website of the goal communication system 500. The merchant may use these applications to enroll in the goal communication system 500 and to communicate (or update) price information, deal or offer information, or the like related to the one or more goals of the consumer associated with the goal communication system 500. The memory system 420 may also include consumer transaction data 424 and/or goal account balances 423 stored therein.

In some embodiments, the financial management system 500 tracks or monitors the goal accounts of the consumer. In certain embodiments of the invention, the consumer goal account data is communicated to the merchant system 400 for providing goal account product or service information and goal account balances so that the merchant system 400 can determine offers to present to the consumer. In some instances, this information is provided in real time or substantially real time relative to when the consumer is actually at or near the location of the merchant.

The merchant system 400 may also include, in some embodiments, one or more positioning system devices 470, such as one or more proximity sensors for sensing a consumer mobile device 200 entering or leaving the merchant's location. For example, in one embodiment of the invention, the merchant has one or more sensors/transceivers located at the entrances and exits to the merchant's location that are configured to detect when a consumer 110 going through the entrance or exit holding a mobile device 200 that is configured to communicate a consumer identifier to the sensors/transceivers. The consumer location information gathered by the positioning system devices 470 is then communicated to the goal communication system 500 so that the goal communication system 500 knows whether the consumer 110 is at, entering, or exiting the merchant facility. In other embodiments of the invention, the merchant may be mobile and, as such, some embodiments of the positioning devices 470 are GPS devices indicating the location of the merchant so that the goal communication system 500 can determine the merchant's location relative to the location of one or more consumers. It will be appreciated that, in some embodiments of the invention, the merchant system 400 does not have any positioning system devices 470 since, for example, a GPS system or a similar system not associated with the merchant system 400 may be used to determine the location of the consumer 110, while the merchant locations may already be known and stored in the memory of the goal communication system 500.

FIG. 5 provides a block diagram illustrating the balance communication system 500 of FIG. 1 in more detail in accordance with an embodiment of the invention. The goal communication system 500 generally includes a processor 510 communicably coupled to a communication interface 530 and a memory system 520. Like the processor 210 described above with respect to FIG. 2, the processor 510 comprises the circuitry and logic to perform the various functions of the goal communication system 500 described herein. The communication interface 530 includes a network interface 532 and a user interface 534, which may be similar to those described above with respect to FIG. 2. The memory system 520 includes a goal communication system application 521 including computer-executable processor code that instructs the processor 510 to perform the various functions described herein as being performed by the goal communication system 500. The memory system 520 also includes merchant and consumer location data 525, consumer transaction data 524, consumer preference data 522, and goal account data 523 stored therein.

The merchant and consumer location data 525 includes location data for each of a plurality of merchants and each of a plurality of participating consumers 110. According to various embodiments, the merchant location data may be determined by public directories containing addresses of various merchants, from the merchant system 400 for some merchants, from the positioning system 150, the financial management system 300, and/or other systems or entities that provide addresses or other location information for one or more merchants. The consumer location data is received from the positioning system 150, which as described above, determines the consumer's current location and/or travel history by tracking the position of the consumer's mobile device 200 over time.

The consumer transaction data 524 includes information about one or more consumer transactions, such as transaction amount, time, location, merchant, products, transaction type, coupons used, payment method, and/or the like. The goal communication system 500 may receive the consumer transaction data 524 from the financial management system 300, the merchant system 400, the consumer mobile device 200, and/or other systems. In some embodiments of the invention, the goal communication system application 521 (when executed by the processor 510) maps the consumer transaction data 524 against the merchant and consumer location data 525 by, amongst other things, correlating the time of each consumer transaction with the consumer's location at that time and by comparing the consumer's location with the locations of a plurality of merchants. In this way, spending trends are identified for each consumer 110.

The consumer preference data 522 may include, for example, information used by the goal communication system 500 to determine the type(s) of goal account(s) for which the consumer 110 may be interested in viewing goal information, when the consumer 110 would like to receive goal information, how the consumer 110 would like to receive goal information, when the consumer 110 would like for the consumer's location to be tracked by the goal communication system 500, the particular distance range between the consumer mobile device and the merchant location when goal should be communicated to the mobile device 200, and/or the like. The consumer preference data 522 may be, for example, consumer-generated and received from the consumer mobile device 200. The consumer preference data 522 may also be determined by the goal communication system 500 automatically and/or based on trends identified in the consumer transaction data 524. Some examples of consumer preference data 522 are described in greater detail below with reference to the flow charts shown in FIGS. 6 through 8.

The goal account data 523 may include, for example, for each goal and/or spending account: a goal balance amount, a goal account product, a merchant or type(s) of merchant(s) associated with the goal account, merchant category code(s) associated with the goal account, and a goal account name. In some embodiments, at least a portion of the goal account data 523 is provided to the goal communication system 500 from the financial management system 300, and in other embodiments, the goal account data 523 is provided directly to the goal communication system 500. Some examples of goal account data 523 are described in greater detail below with reference to FIG. 6 through 11.

FIG. 6 is a flowchart providing an overview of a system and method 600 for providing location-based balance information, in accordance with an embodiment of the invention. It will be understood that one or more devices, such as one or more mobile devices and/or one or more other computing devices and/or servers, can be configured to perform one or more steps of the system and method 600. In some embodiments, the one or more devices performing the steps are associated with a financial institution. In other embodiments, the one or more devices performing the steps are associated with a business, third party, and/or user.

As represented by block 602, the system receives input from the user regarding a goal related to money or credit amount that the user desires to accumulate in order to complete a purchase for a corresponding product or service in the future. In an embodiment, the user may provide the input regarding the goal to an online financial account associated with the user. In such an embodiment, the user may set up one or more goals for saving within the online financial account, where in some instances, the goals for saving correspond to a specific product or service that the user intends to purchase at a time in the future. In another embodiment, the system may receive input from the user for setting up one or more sub-accounts, where the user can provide input for designating each sub-account for a specific product or service for future purchase, and also where the user can provide input for funding each sub-account separately from the primary account associated with the online financial account. It will be understood that the system may receive input from the user in any manner including via one or more input devices and/or one or more input devices associated with a mobile device, stationary computing device, or any other computing device accessible to the user for inputting goal information.

As represented by block 604, the system monitors information associated with the goals of the user, and in particular, the balance associated with the goal account or the amount of money or credit accumulated towards the goal amount that is currently accumulated in the goal account. For example, in one embodiment of the invention, the system is in constant or frequent communication with a goal account and/or financial account associated with the user and which the user uses for saving money or credit amounts for the goal. In another embodiment, the system monitors price or promotion information associated with the goal and/or the goal account product or service. For example, in one embodiment of the invention, the system is in constant communication with merchant system 400. So when, for example, the price of the product or service changes and/or there is an ongoing promotion for the product, the system receives this information about the product so that the system can determine whether the user has met his or her goal according to the new price or promotion. In some embodiments, promotions may include, but is not limited to, sales, discounts, rebates, coupons, financing opportunities, and/or the like that reduces the overall cost of the product or makes the acquisition of the product by the user easier. In some embodiments, the price or promotion information can be received from the merchant system 400 in real-time or substantially real-time as the price changes occur or as the promotions are determined or implemented by a merchant.

As represented by block 606, the system determines when the user is at or near a merchant location. For example, in one embodiment of the invention, the positioning system 150 determines the location of the consumer's mobile device 200 relative to the world or other geography (e.g., via a GPS system or similar system). In another example embodiment, proximity sensors are located proximate to one or more merchants, and these sensors can determine when the consumer mobile device 200 is visiting, approaching, and/or leaving the one or more merchants. For example, participating merchants may install sensors at each entrance and exit of the merchant location and determine that a consumer 110 is visiting the merchant location by sensing the positioning system device 275 of the consumer mobile device 200 when the consumer 110 walks through an entrance with the consumer mobile device 200. In such an embodiment, the goal communication system 200 may determine that the consumer 110 is leaving the merchant location by either having dedicated exits, by determining the proximity of the consumer mobile device 200 to an exit, or by determining that the consumer 110 must be exiting if the consumer mobile device 200 is sensed in an entrance/exit after being sensed when the consumer 110 entered the merchant location. In another embodiment of the invention, the consumer mobile device 200 has a sensor configured to sense transmitters or other devices located proximate one or more merchants (e.g., at the entrances and exits of the merchant's location) and then communicates the sensed information to the goal communication system 500.

Then, as represented by block 608, the balance communication system 500 identifies a merchant that is located within a particular distance range of the consumer's mobile device 200 that offers for sale a product associated with at least one goal of the user. According to various embodiments, for example, the goal communication system 500 compares the consumer's mobile device's 200 location to the known location (e.g., address) of one or more merchants. For example, in one embodiment, the balance communication system 500 utilizes a database storing merchant locations to determine which merchant locations are within the particular distance range of the consumer's mobile device 200. Similarly, in one embodiment, the goal communication system 500 utilizes a database that stores information relating to product inventories or service offering of merchants associated with the database so that the system can determine whether any of the merchant locations in proximity to the user offers for sale any products or services associated with the goals of the user. According to some embodiments, the particular distance range is between 0 and about 200 feet, and in one embodiment, the particular distance range is between 0 and about 50 feet. In yet another embodiment, the particular distance range is less than about 50 feet. In other embodiments, the distance range may include other distances (e.g., one mile, a half mile, a quarter kilometer, etc.). The particular distance range, according to various embodiments, is set by the consumer 110 via the goal communication system client application 221 and is stored as consumer preference data 522. Some embodiments of the system may have a distance range of zero and require that the consumer enter the merchant location. Additionally, in the merchant identification process once the goal communication system 500 determines the various merchant locations relative to the location of the mobile device associated with the consumer, the system compares the merchant inventory or products for sale with the one or more goals of the user. So that the system can determine which of the merchant locations offer for sale or have in stock the one or more products or services associated with the one or more goals of the user.

In some embodiments, once the balance communication system 500 identifies a merchant location offering for sale a product or service associated with a goal of the consumer, the system sends a notification to the merchant. In some embodiments, the notification sent to the merchant comprises information relating to the goal. In some embodiments, the information relating to the goal may include the product or service the consumer desires to purchase, the amount the consumer has saved towards the goal, the consumer's location relative to the merchant, and/or the like. In this way, the system allows the merchant to present, via the mobile device associated with the user, an offer or promotion that the user can utilize for obtaining the specific product. For example, a goal product that the consumer may have associated with his goal account may be a $1000 television, where the consumer currently has $950 saved in the goal account saved towards the television, and where the consumer is in a location near or at an identified merchant selling the television. In this instance, this information about the consumer's goal product, amount saved, and location is sent to the merchant so that the merchant can determine or evaluate whether it can present an offer to the consumer. The offer from the merchant may be a promotion or discount that reduces the price of the television so that the consumer may make the purchase with the current amount saved. Alternatively, the merchant may present an incentive that does not reduce the price of the tv but encourages the user to purchase the television today. The incentives may include increased ability to earn loyalty points (e.g., double loyalty points if goal product is purchased today), a give-away (e.g., a gift card, an accessory to the goal product, or the like) to be given in combination with the purchase, or the like. The incentive can be any one or combination of items or benefits offered by the merchant that encourages the consumer to purchase the television. In some embodiments, the offer presented by the identified merchant is a financing offer, a coupon, discount, payment plan, rebate, substitute product, and/or the like. For example, in some embodiments, the system indicates to an identified merchant that the user is searching for a certain brand of television with certain specifications for an amount not exceeding a certain price and the current amount the user has accumulated in money or credit in a financial for purchasing the television. In this example, the merchant can respond to the system by providing to the system or mobile device associated with the user an offer, such as a $200 discount, if the user opts to purchase the television from the merchant today. In some embodiments, the merchant is provided with a dashboard that displays or presents to the merchant a real-time or near real-time representation of one or more consumers who are relative to the merchant's location with goals associated with products the merchant offers for sale. In some embodiments, the dashboard is configured to display information related to the consumer's goal and recommendations for offers or promotion that the merchant can present to the user. In some embodiments, using the dashboard, the merchant is able to select a consumer and send an offer, promotion, or sales information to the selected consumer.

In some embodiments, the system is configured to identify a plurality of consumers relative to a merchant location and provide this information to the merchant. In some embodiments, the plurality of consumers is a group of consumers each having a goal product that the merchant offers for sale. In such an embodiment, the system allows the merchant to present or send one or more offers relating to each of the goal products to the plurality of consumers or group of consumers at the same time or nearly the same time. In some embodiments, the promotions or offers presented to the group of consumers are the same. In some embodiments, the promotions or offers present to the group are different and specifically tailored to each of the goal products associated with the group of consumers.

Threshold Triggers

As represented by block 610, the balance communication system 500 communicates information relating to the goal to the mobile device of the user based at least partially on determining the location of the user. In one embodiment, the system communicates information relating to the goal based at least in part on determining both the location of the user and identifying a merchant location near the user that offers for sale the product or service associated with the goal. In some embodiments, the system communicates a notification to the user, where the notification comprises the information relating to the goal. The information relating to the goal may include the progress of the user towards saving for the goal. For example, the notification may include information about the price, such as $1000, of a television the user associated with a goal amount, the goal amount, such as $900, that the user desires to save for the television, and money amount, such as $500, that the user has saved for purchasing the television. The system may provide in real-time or substantially real-time the notification comprising the information regarding the price of the product and/or the money amounts the user has saved towards the goal.

In an embodiment, the system determines an amount that the user needs to satisfy the goal in order to purchase the product associated with the goal and provides recommendations for covering the difference based at least in part on the current price of the product associated with the goal, the amount saved in the financial account associated with the goal, and determining the availability of financing options and/or the availability of promotions for reducing the overall price of the product. In some embodiments, the system determines the difference in funds by determining the difference between the real-time or substantially real-time price of the product associated with the goal and the balance amount in the account associated with the goal. In an example, the goal is a television with a current price of $1000 and the balance of the account associated with the goal is $600. In such an example, the system determines that the amounts necessary for purchasing the television is $400 ($1000-$600). Once the system determines the difference, the system determines one or more options or recommendations that would allow the user to pay for the difference in order to purchase the product today. In some embodiments, the system receives or retrieves information related to one or more financing vehicles or promotion available via the financial management system 300 that the system may recommend for paying for the difference in the price of the product and the amounts saved for the product. A few examples of financing vehicles include recommendation a new or existing credit with a promotional period, recommending transferring money from a different account of the user to the account associated with the goal, recommending various discounts, rebates, or coupons, recommending a payment plan available at the merchant or available for the product type, and/or a combination of the fore-mentioned recommendations. In some embodiments, the system may recommend to user an alternative method such as financing with a new or existing credit card or using an installment plan for paying for the product. In some embodiments, the system may recommend that the user transfer or borrow funds from another goal or goal account of the user for meeting the difference in the amount saved for the goal product and the current price. In some embodiments, the system is configured to sum real-time or near real-time price to purchase the product and the offer or promotion and present the resulting price or amount to a display of the mobile device of the consumer. In another embodiment, the system is configured to display, via the mobile device of the consumer, a plurality prices for the goal product based on the system determining a plurality of offers or promotions for the goal product, wherein some of the offers or promotions have differing values and thus, resulting in different prices.

In some embodiments, the system is configured to a notification to the user, wherein the notification comprises provides a recommendation or offer for an additional product or service that is related to the goal product. For example, in some embodiments, if the goal product is a television then the system may determine that a warranty is available for the television and provide a recommendation that the user purchases a warranty along with the television. The additionally product or service may be anything or service that supplements or is related to the product or service and is not limited to a warranty. For example, the supplemental product or service could also be insurance for the goal product or the like. In some embodiments, the system is configured to sum the price to purchase the goal product and additional product and service and present the total price to purchase both in real-time or near real-time.

In some embodiments, the system is in communication with a social network or social media network associated with the consumer such that the system may communicate to the social network information related to goal of the consumer. In such an embodiment, the system may communicate the amount the consumer has saved for the goal product and the amount the consumer requires for purchasing the goal product. In such an instance, the system may prompt other users associated with the social media network of the user to contribute the additional amounts the consumer requires for making the purchase. In some embodiments, the other users can contribute the additional amounts using peer to peer payments or the like. In some embodiments, the social network associated with the consumer is a shopping circle or group. In some embodiments, the social network is a social media outlet.

It will be understood that the system may present to the user any of the one aforementioned recommendations or offers or promotions either alone or in combination.

In some embodiments, the system is configured to provide a notification to the user based on a predetermined threshold or user-selected threshold. In some embodiments, the system automatically provides a notification to the user that he may be able to purchase the goal product based on the amount saved for the being a certain predetermined percentage of the real-time or near real-time price of the goal product. In some embodiments the threshold is user-selected. In such embodiments, the user may provide a value to the system such that when the goal amount saved or price of the product meets or satisfies that value, a notification is triggered or automatically sent to the mobile device of the consumer. In some embodiments, the price of the goal product or the amount saved towards the goal product is determined in combination with the promotions or offers presented by the system or merchants and/or the amount contributed by others in the consumer's social network or shopping circles.

In some embodiments, the system is configured to analyze the consumer's bank or credit card targeted purchase offers in order to determine whether the consumer has existing promotions or offers that have not been selected. These type of deals or targeted purchase offers are described more fully in application Ser. No. 13/529,981 named “Rule-Based Offer Association”, application Ser. No. 13/529,999 named “Intelligent Offer Tool”, and application Ser. No. 13/529,994 named “Queuing Input Data For View of Customer And Offer Association”, which are hereby incorporated by referenced in their entirety. In such an embodiment, the system is configured to determine the one or more offers related to the goal product and present the un-selected offers to the consumer together with any or no other information related to the goal product.

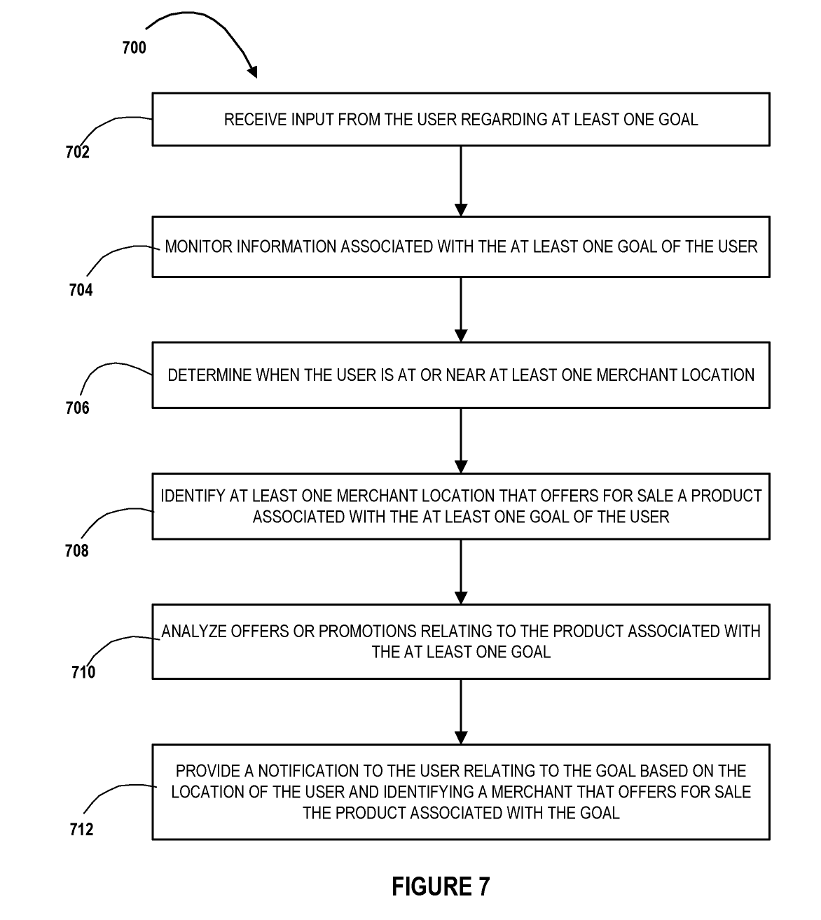

FIG. 7 illustrates a process 700 for providing location-based push information about a goal of the user. The process 700 is similar to process 600 described above in relation to FIG. 6, but in process 700, the system analyzes promotion information related to products corresponding to the goals of the user. In particular, beginning with block 702, the system receives input from the user regarding a goal related to an amount that the user desires to save in order to complete a purchase for a product corresponding to the goal. Then, in block 704, the system monitors information associated with the goals of the user, and in particular, the balance information associated with the goal or the amount saved towards the goal. Next, at block 706, the system determines when the user is at or near a merchant location that provides the product associated with the goal by receiving location information from a mobile device associated with the user. Additionally, at block 708, the system identifies a merchant that is located within a particular distance or range of the consumer's mobile device that offers for sale a product associated with at least one goal of the user. At block 710, the system retrieves or receives information relating to sales, promotions, financing opportunities, coupons, rebates, discounts, and/or the like associated with at least one product corresponding to a goal of the user and determines whether any of the information is applicable for reducing the price of the product or covering a portion of the purchase price of the product not met by the balance in the account associated with the goal. Finally, at block 712, the system communicates information relating to the goal in the form of a notification to a mobile device associated with the consumer.

As represented by block 710 the system analyzes sales, promotions, financing opportunities, coupons, rebates, discounts, and/or the like associated with each product corresponding to a goal of the user and subsequently determines an adjusted progress towards goals for the user based on this information. For example, in response to the system determining the location of the user, the system provides the information relating to the goal of which may be $1000, $900, and $500, which represent the price of television, the user's goal amount, and the user's financial account balance associated with the goal amount. In such an example, the system may determine an adjusted progress towards the goal of the user based on real-time or substantially real-time promotions or sales information provided the merchant system 500 or retrieved from a database comprising information related to sales and promotion information for the product corresponding to the user's goal. In this way, the adjusted progress information may include a notification comprising information about coupons and/or rebates that can be used for purchasing the product, as well as indicator for displaying the adjusted price of the product, such as $650 (Original price $1000 minus a merchant discount of $350) when the promotions are factored into the price determination.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed:

1. A system providing a notification based on location, the system comprising:
a mobile computing device including a processor and a memory; and
a software module stored in the memory, comprising executable instructions that when executed by the processor causes the processor to:
receive a goal from a consumer, wherein the goal corresponds to a specific product the consumer desires to purchase and a money or credit amount the consumer desires to save for purchasing the specific product in the future;
determine a location associated with a mobile device of the consumer;
identify a merchant that is located at or near the location associated with the mobile device of the consumer;
determine whether the merchant offers for sale the specific product associated with the goal; and
provide a notification to the mobile device associated with the consumer based at least in part on determining that the merchant offers for sale the product, the notification comprising information related to the progress of the user towards the goal.

2. The system of claim 1, the system comprising executable instructions that when executed by the processor further causes the processor to:
determine whether the money or credit amount associated with the goal is met; and
wherein providing the notification is based at least in part on determining that the merchant offers for sale the product and determining that the money or credit amount associated with the goal is met.

3. The system of claim 1, the system comprising executable instructions that when executed by the processor further causes the processor to:
determine whether the money or credit amount associated with the goal is met;
determine, when the money or credit amount associated with the goal is not met, a difference between a real-time or substantially real-time price of the specific product and a current amount of the money or credit amount the consumer has available for purchasing the specific product; and
provide a recommendation to the consumer for a payment option for paying for the determined difference, wherein the recommendation comprises one of at least a recommendation to pay for the determined difference using an existing or by opening a new credit line, by transferring funds from a financial account, or by using a payment installment plan.

4. The system of claim 1, the system comprising executable instructions that when executed by the processor further causes the processor to:
receive sales or promotions information associated with the specific product, wherein the sales or promotions relate to at least one of financing opportunities, coupons, rebates, or discounts available to the user for reducing the overall price of the specific product; and
provide a recommendation to the consumer for a sale or promotion based at least in party on an analysis of the received sales or promotions and determining that at least one of the sales or promotions together with a current balance of the money or credit amount is sufficient for purchasing the specific product by the consumer.

5. The system of claim 1, the system comprising executable instructions that when executed by the processor further causes the processor to:
send a notification to the identified merchant, the notification comprising information indicating that the consumer is at or near the identified merchant and further indicating that the consumer has a goal corresponding to a specific product that the identified merchant has for sale; and
allow the identified merchant to send, in real-time or substantially real-time, an offer to the mobile device associated with the consumer and while the consumer is at or near the identified merchant.

6. The system of claim 1, wherein the information related to the progress of the user towards the goal includes at least a balance of a financial account having the money or credit amount the user has accumulated for purchasing the specific product, the goal amount, and a current price of the specific product.

7. The system of claim 1, the system comprising executable instructions that when executed by the processor further causes the processor to:
receive a plurality of goals from the consumer, wherein each of the plurality of goals correspond to a specific product the consumer desires to purchase and a money or credit amount the consumer desires to save for purchasing the specific product in the future;
identify a plurality of merchants that are located at or near the location associated with the mobile device of the consumer; and
present, via the mobile device of the consumer, a two or more notifications based at least in part on determining that at least one of the plurality of merchants offers two or more specific products associated with the plurality of goals of the consumer.

8. A computer-implemented method comprising:
using a computer processor to execute computer program code instructions stored in one or more non-transitory computer-readable mediums, wherein said computer program code instructions are structured to cause said computer processor to:
receive a goal from a consumer, wherein the goal corresponds to a specific product the consumer desires to purchase and a money or credit amount the consumer desires to save for purchasing the specific product in the future;
determine a location associated with a mobile device of the consumer;
identify a merchant that is located at or near the location associated with the mobile device of the consumer;
determine whether the merchant offers for sale the specific product associated with the goal;
provide a notification to the mobile device associated with the consumer based at least in part on determining that the merchant offers for sale the product, the notification comprising information related to the progress of the user towards the goal.

9. The computer-implemented method of claim 8, the method further comprising:
determining whether the money or credit amount associated with the goal is met; and
wherein providing the notification is based at least in part on determining that the merchant offers for sale the product and determining that the money or credit amount associated with the goal is met.

10. The computer-implemented method, the method further comprising:
determining whether the money or credit amount associated with the goal is met;
determining, when the money or credit amount associated with the goal is not met, a difference between a real-time or substantially real-time price of the specific product and a current amount of the money or credit amount the consumer has available for purchasing the specific product; and
providing a recommendation to the consumer for a payment option for paying for the determined difference, wherein the recommendation comprises one of at least a recommendation to pay for the determined difference using an existing or by opening a new credit line, by transferring funds from a financial account, or by using a payment installment plan.

11. The computer-implemented method of claim 8, the method further comprising:
receiving sales or promotions information associated with the specific product, wherein the sales or promotions relate to at least one of financing opportunities, coupons, rebates, or discounts available to the user for reducing the overall price of the specific product; and
providing a recommendation to the consumer for a sale or promotion based at least in party on an analysis of the received sales or promotions and determining that at least one of the sales or promotions together with a current balance of the money or credit amount is sufficient for purchasing the specific product by the consumer.

12. The computer-implemented method of claim 8, the method further comprising:
sending a notification to the identified merchant, the notification comprising information indicating that the consumer is at or near the identified merchant and further indicating that the consumer has a goal corresponding to a specific product that the identified merchant has for sale; and
allowing the identified merchant to send, in real-time or substantially real-time, an offer to the mobile device associated with the consumer and while the consumer is at or near the identified merchant.

13. The computer-implemented method of claim 8, wherein the information related to the progress of the user towards the goal includes at least a balance of a financial account having the money or credit amount the user has accumulated for purchasing the specific product, the goal amount, and a current price of the specific product.

14. The computer-implemented method of claim 8, the method further comprising:
receiving a plurality of goals from the consumer, wherein each of the plurality of goals correspond to a specific product the consumer desires to purchase and a money or credit amount the consumer desires to save for purchasing the specific product in the future;
identifying a plurality of merchants that are located at or near the location associated with the mobile device of the consumer; and
presenting, via the mobile device of the consumer, a two or more notifications based at least in part on determining that at least one of the plurality of merchants offers two or more specific products associated with the plurality of goals of the consumer.

15. A computer program product, the computer program product comprising a non-transitory computer-readable storage medium having computer-readable program code stored thereon, such that when the computer-readable code is executed by a computer processor it causes the computer to:
receive a goal from a consumer, wherein the goal corresponds to a specific product the consumer desires to purchase and a money or credit amount the consumer desires to save for purchasing the specific product in the future;
determine a location associated with a mobile device of the consumer;
identify a merchant that is located at or near the location associated with the mobile device of the consumer;
determine whether the merchant offers for sale the specific product associated with the goal; and
provide a notification to the mobile device associated with the consumer based at least in part on determining that the merchant offers for sale the product, the notification comprising information related to the user's progress towards the goal.

16. The computer program product of claim 15, further comprising computer-readable code is executed by a computer processor it causes the computer to:
determine whether the money or credit amount associated with the goal is met; and
wherein providing the notification is based at least in part on determining that the merchant offers for sale the product and determining that the money or credit amount associated with the goal is met.

17. The computer program product of claim 15, further comprising computer-readable code is executed by a computer processor it causes the computer to:
determine whether the money or credit amount associated with the goal is met;
determine, when the money or credit amount associated with the goal is not met, a difference between a real-time or substantially real-time price of the specific product and a current amount of the money or credit amount the consumer has available for purchasing the specific product; and
provide a recommendation to the consumer for a payment option for paying for the determined difference, wherein the recommendation comprises one of at least a recommendation to pay for the determined difference using an existing or by opening a new credit line, by transferring funds from a financial account, or by using a payment installment plan.

18. The computer program product of claim 15, further comprising computer-readable code is executed by a computer processor it causes the computer to:
receiving sales or promotions information associated with the specific product, wherein the sales or promotions relate to at least one of financing opportunities, coupons, rebates, or discounts available to the user for reducing the overall price of the specific product; and
providing a recommendation to the consumer for a sale or promotion based at least in party on an analysis of the received sales or promotions and determining that at least one of the sales or promotions together with a current balance of the money or credit amount is sufficient for purchasing the specific product by the consumer.

19. The computer program product of claim 15, further comprising computer-readable code is executed by a computer processor it causes the computer to:
sending a notification to the identified merchant, the notification comprising information indicating that the consumer is at or near the identified merchant and further indicating that the consumer has a goal corresponding to a specific product that the identified merchant has for sale; and
allowing the identified merchant to send, in real-time or substantially real-time, an offer to the mobile device associated with the consumer and while the consumer is at or near the identified merchant.

20. The computer program product of claim 15, wherein the information related to the progress of the user towards the goal includes at least a balance of a financial account having the money or credit amount the user has accumulated for purchasing the specific product, the goal amount, and a current price of the specific product.
